(19) United States
(12) Patent Application Publication
(10) Pub. No.: US 2026/0361428 A1
(43) Pub. Date: Nov. 12, 2026

(54) METHOD FOR SELF TEST OF FREQUENCY USAGE DETECTION SENSOR AND APPARATUS FOR THE SAME

(71) Applicant: ELECTRONICS AND TELECOMMUNICATIONS RESEARCH INSTITUTE, Daejeon (KR)

(72) Inventor: Sung Jun LEE, Daejeon (KR)

(73) Assignee: ELECTRONICS AND TELECOMMUNICATIONS RESEARCH INSTITUTE, Daejeon (KR)

(21) Appl. No.: 19/669,595

(22) Filed: May 6, 2026

(30) Foreign Application Priority Data
May 8, 2025 (KR) 10-2025-0059442

(51) Int. Cl. H04B 17/29

(52) U.S. Cl. CPC H04B 17/297

(57) ABSTRACT

The present disclosure relates to a method for self-testing whether a frequency usage detection sensor operates normally and an apparatus for the same. The self-test method of a frequency usage detection sensor according to an embodiment of the present disclosure may include transmitting a test signal by an apparatus; based on an inherent characteristic of the test signal received by the apparatus, checking whether a sensing operation of the apparatus is abnormal or not; and based on a signal obtained by removing the test signal received by the apparatus from an entire signal received by the apparatus, determining whether a frequency is used.

### CROSS-REFERENCE TO RELATED APPLICATIONS

This application claims the benefit of earlier filing date and right of priority to Korean Application No. 10-2025-0059442, filed on May 8, 2025, the contents of which are all hereby incorporated by reference herein in their entirety.

### TECHNICAL FIELD

The present disclosure relates to a self-test of a sensor and specifically, relates to a method for self-testing whether a frequency usage detection sensor operates normally and an apparatus for the same.

### BACKGROUND ART

A frequency sharing technology is being developed and applied to respond to the increasing demand for frequency. A frequency sharing technology may include a sharing method that allows a secondary user to use a corresponding frequency when an incumbent user with priority over using the corresponding frequency does not use the corresponding frequency.

For such frequency sharing, it is required to accurately determine whether an incumbent user uses a frequency. For example, a sensor that determines whether an incumbent user uses a frequency may periodically report to a spectrum access system the sensing results. If the sensing operation of a frequency usage detection sensor is abnormal but an operator is unaware of it, an abnormality may occur in frequency sharing based on the sensing results from such a sensor. For example, when an incumbent user is actually using a frequency but is incorrectly determined not to be using it, a secondary user attempts to transmit a signal at a corresponding frequency, which may cause interference between an incumbent and secondary user. Alternatively, when an incumbent user is not actually using a frequency but is incorrectly determined to be using it, a secondary user is unable to use a corresponding frequency even though a secondary user is able to use it, which may reduce frequency usage efficiency. To prevent this problem, a method that can self-test whether a frequency usage detection sensor operates normally is required.

### DISCLOSURE

### Technical Problem

The present disclosure is to provide a method and an apparatus for self-testing whether a sensor operates normally in its installed state, i.e., in an in-situ manner.

The present disclosure is to provide a method and an apparatus for self-testing whether a sensor operates normally without stopping the sensing operation of a frequency usage detection sensor, i.e., in an in-service manner.

The present disclosure is to provide a self-test method and apparatus that may minimize the impact of the self-test of a frequency usage detection sensor on the sensing performance of the frequency usage detection sensor.

The present disclosure is to provide a method and an apparatus for self-testing whether an abnormality is present or not in the entire sensing operation by the radio frequency (RF) component, analog component, digital component and sensing antenna of a frequency usage detection sensor.

The technical objects to be achieved by the present disclosure are not limited to the above-described technical objects, and other technical objects which are not described herein will be clearly understood by those skilled in the pertinent art from the following description.

### Technical Solution

The self-test method of a frequency usage detection sensor according to an embodiment of the present disclosure may include transmitting a test signal by an apparatus; based on an inherent characteristic of the test signal received by the apparatus, checking whether a sensing operation of the apparatus is abnormal or not; and based on a signal obtained by removing the test signal received by the apparatus from an entire signal received by the apparatus, determining whether a frequency is used.

An apparatus for performing a self-test for a frequency usage detection sensor according to an additional embodiment of the present disclosure may include at least one transceiver; and at least one processor. The at least one processor may be configured to transmit a test signal through a specific transmitter among the at least one transceiver; based on an inherent characteristic of the test signal received by a specific receiver among the at least one transceiver, check whether a sensing operation of the apparatus is abnormal or not; and based on a signal obtained by removing the test signal received by the specific receiver from an entire signal received by the specific receiver, determine whether a frequency is used.

A processing unit according to an additional embodiment of the present disclosure may include at least one processor; and at least one local memory operatively connected to the at least one processor, and based on being executed by the at least one processor, storing instructions for performing an operation for based on an inherent characteristic of a test signal transmitted by an apparatus and received by the apparatus, checking whether a sensing operation of the apparatus is abnormal or not; and an operation for based on a signal obtained by removing the test signal received by the apparatus from an entire signal received by the apparatus, determining whether a frequency is used.

In at least one non-transitory computer-readable medium for storing at least one instruction according to an additional embodiment of the present disclosure, the at least one instruction may be executed by at least one processor to control an apparatus to perform an operation for based on an inherent characteristic of a test signal transmitted by the apparatus and received by the apparatus, checking whether a sensing operation of the apparatus is abnormal or not; and an operation for based on a signal obtained by removing the test signal received by the apparatus from an entire signal received by the apparatus, determining whether a frequency is used.

In some embodiments of the present disclosure, checking whether the sensing operation of the apparatus is abnormal or not may include determining whether a sensing operation is abnormal or not based on a comparison between a reference channel impulse response (CIR) and a CIR measurement result between a transmit and a receive antenna obtained based on the inherent characteristic of the test signal transmitted by the apparatus and received by the apparatus when transmission and reception of the test signal are time-synchronized within the apparatus.

In some embodiments of the present disclosure, the reference CIR may be set as a CIR between a transmit and a receive antenna measured at first installation after the apparatus is verified.

In some embodiments of the present disclosure, determining whether the sensing operation is abnormal or not based on the comparison between the CIR measurement result and the reference CIR may include determining whether the sensing operation is normal according to whether a difference in at least one of a time delay or a dynamic range (DR) of the CIR measurement result and the reference CIR is within a predetermined certain range.

In some embodiments of the present disclosure, when the difference between the CIR measurement result and the reference CIR is not within the predetermined certain range, it is determined that the sensing operation of the apparatus has the abnormality or is not normal, and when the difference between the CIR measurement result and the reference CIR is within the predetermined certain range, it is determined that the sensing operation of the apparatus does not have the abnormality or is normal or it may include additionally determining whether the sensing operation of the apparatus is abnormal or not based on machine learning.

In some embodiments of the present disclosure, removing the test signal received by the apparatus from the entire signal received by the apparatus may include removing an estimate of a baseband signal of the received test signal from a baseband signal of the received entire signal.

In some embodiments of the present disclosure, the estimate of the baseband signal of the received test signal may be obtained by applying a time delay estimation value and a magnitude change estimation value for a baseband signal of the transmitted test signal to the baseband signal of the transmitted test signal.

In some embodiments of the present disclosure, the time delay estimation may be performed by taking a response with a largest dynamic range (DR) in the CIR measurement result, that is, a time delay of a primary signal path.

In some embodiments of the present disclosure, the magnitude change estimation may be performed based on adjusting a magnitude change value in a direction that reduce the largest DR of the primary signal path.

In some embodiments of the present disclosure, the test signal may be generated based on a pseudo noise (PN) sequence.

In some embodiments of the present disclosure, the inherent characteristic of the test signal may be an auto-correlation characteristic of the PN sequence.

In some embodiments of the present disclosure, the test signal may be generated based on a linear frequency modulation (LFM) signal.

In some embodiments of the present disclosure, the inherent characteristic of the test signal may be a de-chirping characteristic of the LFM signal.

In some embodiments of the present disclosure, determining whether the frequency is used based on the signal obtained by removing the received test signal from the received entire signal may include, based on a comparison between a predetermined threshold value and a received power in a specific channel of the signal obtained by removing the received test signal from the received entire signal, determining whether an incumbent user uses the frequency in the specific channel.

In some embodiments of the present disclosure, determining whether the frequency is used based on the signal obtained by removing the received test signal from the received entire signal may include determining that the incumbent user does not use the frequency of the specific channel when the received power in the specific channel is less than the predetermined threshold value, determining that the incumbent user uses the frequency of the specific channel when the received power in the specific channel is greater than or equal to the predetermined threshold value or additionally determining whether the incumbent user uses the frequency of the specific channel based on a machine learning algorithm.

In some embodiments of the present disclosure, a sensing result of determining whether the frequency is used may be periodically reported to a spectrum access system.

In some embodiments of the present disclosure, when it is determined that the sensing operation of the apparatus is abnormal as a result of the self-test, the periodic report may be stopped.

In some embodiments of the present disclosure, when a determination on whether the frequency is used determines that the incumbent user uses the frequency, a transmission of the test signal may be stopped in the apparatus.

In some embodiments of the present disclosure, when the transmission of the test signal is stopped, whether the frequency is used may be determined based on the received entire signal.

In some embodiments of the present disclosure, transmit power of the test signal may be set to ensure that received power of the test signal is less than or equal to a noise floor of a receiver of the apparatus.

In some embodiments of the present disclosure, the self-test may be performed in an in-situ manner and an in-service manner.

The features briefly summarized above for the present disclosure are just an exemplary aspect of a detailed description for the present disclosure described below, and do not limit the scope of the present disclosure.

### Technical Effect

According to the present disclosure, a method for self-testing whether a sensor operates normally in its installed state, i.e., in an in-situ manner, and an apparatus for the same may be provided.

According to the present disclosure, a method for self-testing whether a sensor operates normally without stopping the sensing operation of a frequency usage detection sensor, i.e., in an in-service manner, and an apparatus for the same may be provided.

According to the present disclosure, a self-test method that may minimize the impact of the self-test of a frequency usage detection sensor on the sensing performance of the frequency usage detection sensor and an apparatus for the same may be provided.

According to the present disclosure, a method for self-testing whether an abnormality is present or not in the entire sensing operation by the radio frequency (RF) component, analog component, digital component and sensing antenna of a frequency usage detection sensor and an apparatus for the same may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 represents the concept of spectrum sensing-based frequency sharing to which the present disclosure may be applied.

FIG. 2 represents an example of the configuration of a frequency usage detection sensor with only a sensing function.

FIG. 3 is a diagram for describing an example of a sensing operation.

FIG. 4 is a diagram representing an example of the structure of a frequency usage detection sensor with a self-test function according to the present disclosure.

FIG. 5 represents an example of a channel impulse response (CIR) between a transmit and a receive antenna according to the present disclosure.

FIG. 6 represents an example of a CIR when the estimate of a baseband test signal is removed from the example of FIG. 5.

FIG. 7 is a diagram for describing an example of magnitude change estimation for a test signal according to the present disclosure.

FIG. 8 is a diagram for describing another example of magnitude change estimation for a test signal according to the present disclosure.

FIG. 9 is a diagram for describing an example of self-test and sensing operations according to the present disclosure.

FIG. 10 is a diagram for describing an example of the self-test method and frequency usage detection method of a frequency usage detection sensor according to the present disclosure.

FIG. 11 represents an example of a block diagram of a frequency usage detection sensor with a self-test function according to the present disclosure.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in the idea and technical scope of the present disclosure. A similar reference numeral in a drawing refers to a like or similar function across multiple aspects. The shape and size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented as another embodiment without departing from the scope and spirit of the present disclosure in connection with an embodiment. In addition, it should be understood that the position or arrangement of an individual component in each disclosed embodiment may be changed without departing from the scope and spirit of an embodiment. Accordingly, a detailed description described below is not taken as a limited meaning and the scope of exemplary embodiments, if properly described, is limited only by an accompanying claim along with any scope equivalent to that claimed by those claims.

In the present disclosure, a term such as first, second, etc. may be used to describe a variety of components, but the components should not be limited by the terms. The terms are used only to distinguish one component from other components. For example, without departing from the scope of a right of the present disclosure, the first component may be referred to as the second component and likewise, the second component may be also referred to as the first element. A term of “and/or” includes a combination of a plurality of relevant described items or any of a plurality of relevant described items.

When a component in the present disclosure is referred to as being “linked” or “connected” to other component, it should be understood that it may be directly linked or connected to other component, but another component may exist in the middle. On the other hand, when a component is referred to as being “directly linked” or “directly connected” to other component, it should be understood that another component does not exist in the middle.

As construction units shown in the embodiment of the present disclosure are independently shown to represent different characteristic functions, it does not mean that each construction unit is constructed in the construction unit of separate hardware or one software. In other words, as each construction unit is included by being enumerated as each construction unit for convenience of description, at least two construction units of each construction unit may be combined to form one construction unit or one construction unit may be divided into a plurality of construction units to perform a function, and the integrated embodiment and separate embodiment of each construction unit are also included in the scope of a right of the present disclosure unless they are beyond the essence of the present disclosure.

As a term used in the present specification is just used to describe a specific embodiment, it is not intended to limit the present disclosure. Expression of the singular includes expression of the plural unless it clearly has a different meaning contextually. In the present disclosure, it should be understood that a term such as “include” or “have”, etc. is to designate the existence of features, numbers, steps, motions, components, parts or combinations thereof described on the specification and is not to exclude the existence or possibility of addition of one or more other features, numbers, steps, motions, components, parts or combinations thereof in advance. In other words, a description of “including” a specific configuration in the present disclosure does not exclude a configuration other than a corresponding configuration, and it means that an additional configuration may be included in the scope of a technical idea of the present disclosure or the embodiment of the present disclosure.

Some components of the present disclosure are not a necessary component which performs an essential function in the present disclosure, but may be an optional component just for improving performance. The present disclosure may be implemented by including only a construction unit which is necessary to implement the essence of the present disclosure except for a component used just for performance improvement, and a structure including only a necessary component except for an optional component used just for performance improvement is also included in the scope of a right of the present disclosure.

Hereinafter, the embodiment of the present disclosure will be described in detail by referring to drawings. In describing the embodiment of the present specification, when it is determined that a detailed description on a relevant disclosed construction or function may obscure the gist of the present specification, such a detailed description is omitted, and the same reference numeral is used for the same component on a drawing and an overlapping description on the same component is omitted.

The present disclosure is a new method for self-testing whether a frequency usage detection sensor operates normally, and relates to a self-test method that may be performed without stopping the sensing operation of a frequency usage detection sensor. It may be expressed as in-service monitoring in that a test/monitoring is performed during a sensing operation and may also be expressed as a built-in self-test in that a test/monitoring is performed by a sensor itself.

As the demand for frequency increases, the need for frequency sharing is growing. In particular, the need for frequency sharing in a specific band where the demand is concentrated is being further emphasized, such as a preference for a mid-band with strengths in terms of both coverage and capacity.

As an attempt on frequency sharing, a spectrum sensing (frequency usage detection)-based frequency sharing may be used, which detects the frequency usage of an incumbent user who uses a frequency intermittently and allows a secondary user to use the frequency when an incumbent user does not use a corresponding frequency. The U.S. Citizens Broadband Radio Service (CBRS) is an example of opening up the 150 MHz bandwidth of a 3.5 GHz band used for public purposes such as the military, a satellite, etc. for commercial use based on this sensing-based frequency sharing.

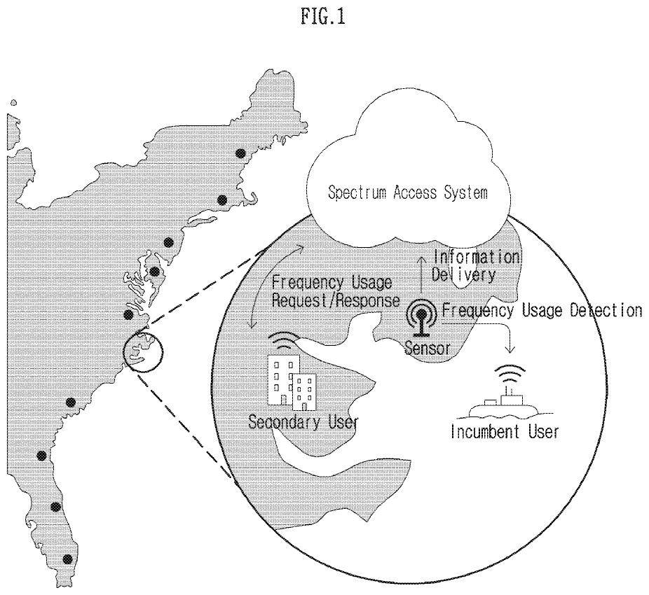

FIG. 1 represents the concept of spectrum sensing-based frequency sharing to which the present disclosure may be applied.

The example of FIG. 1 corresponds to a CBRS scenario. Specifically, when a sensor reports its sensing result (determining whether an incumbent user uses a frequency) to a spectrum access system (or a frequency access system), and the system receives a determination that an incumbent user does not use the frequency, the system may allow a secondary user to use the corresponding frequency.

Specifically, a frequency usage detection sensor may periodically report its sensing result (determining whether an incumbent user uses a frequency) to a spectrum access system. A secondary user may periodically request frequency usage from a spectrum access system. The spectrum access system may respond to the secondary user's request according to the sensing result reported by a frequency usage detection sensor. For example, when it is reported that an incumbent user is using a frequency, a secondary user may be restricted from using the corresponding frequency.

When an abnormality is present in the ‘sensing’ (i.e., detect the frequency usage of an incumbent user) or ‘reporting’ operation of this frequency usage detection sensor, a secondary user may also use the same frequency when an incumbent user uses a frequency, which may cause mutual signal interference, so a problem may occur in spectrum sensing-based frequency sharing.

Whether an abnormality is present or not in a ‘reporting’ operation may be confirmed by whether a report is periodically transmitted from a frequency usage detection sensor to a spectrum access system. In other words, when a report is transmitted at a determined period, it may be determined that no abnormality is present in a ‘reporting’ operation.

The content of a report (a result of determining whether an incumbent user uses a frequency) is meaningful only when no abnormality is present in a ‘sensing’ operation. Accordingly, when an abnormality occurs in a ‘sensing’ operation, it shall be possible to know it. Whether an abnormality is present or not in a ‘sensing’ operation is possible only through the self-test of a frequency usage detection sensor.

When it is confirmed that a ‘sensing’ operation of a frequency usage detection sensor is abnormal, a mutual operation between each entity may be performed to respond to an abnormality. The following operations for responding to the abnormality correspond to an example, and operations will be performed may be predetermined.

For example, a frequency usage detection sensor may stop a periodic report to a spectrum access system when confirming the abnormality of a ‘sensing’ operation.

For example, when a spectrum access system recognizes that an abnormality occurred in a frequency usage detection sensor, it may notify a frequency usage detection sensor operating agency of the abnormality and/or respond to a secondary user's request for frequency usage by assuming that an incumbent user uses all frequencies in an area in charge of a frequency usage detection sensor.

For example, when a frequency usage detection sensor operating agency solves an abnormality, the sensor may return to a normal operation. This normal operation may include, for example, an operation that the self-test of the frequency usage detection sensor is performed again, a result of the test confirms that no abnormality is present in the ‘sensing’ operation, a periodic report is transmitted from the frequency usage detection sensor to a spectrum access system and the spectrum access system responds to a secondary user's request for frequency usage according to the reported content.

Specific examples for the self-test of a frequency usage detection sensor described below enable in-service monitoring and built-in self-test and may be performed in an in-situ manner (i.e., in its installed state) and may be performed in an in-service manner (i.e., without stopping a sensing operation).

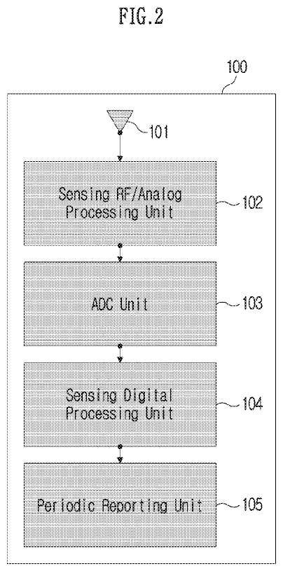

FIG. 2 represents an example of the configuration of a frequency usage detection sensor with only a sensing function.

The receiver structure of FIG. 2 may be a digital-intermediate frequency (IF) or a digital-baseband (BB). When a receiver structure is a digital-IF, frequency down-conversion to a baseband may be performed in the sensing digital processing unit 104.

The sensing antenna 101 may convert a radio wave to an electric signal.

The sensing RF/analog processing unit 102 may perform filtering/frequency down-conversion (converting an RF to an IF or a BB) and amplify it to a magnitude that may be handled by the analog to digital converter (ADC) unit 103.

The ADC unit 103 may convert an analog signal to a digital signal.

The sensing digital processing unit 104 may determine whether a frequency is used by using a baseband signal.

The periodic reporting unit 105 may periodically report a result of determining whether a frequency is used to a spectrum access system.

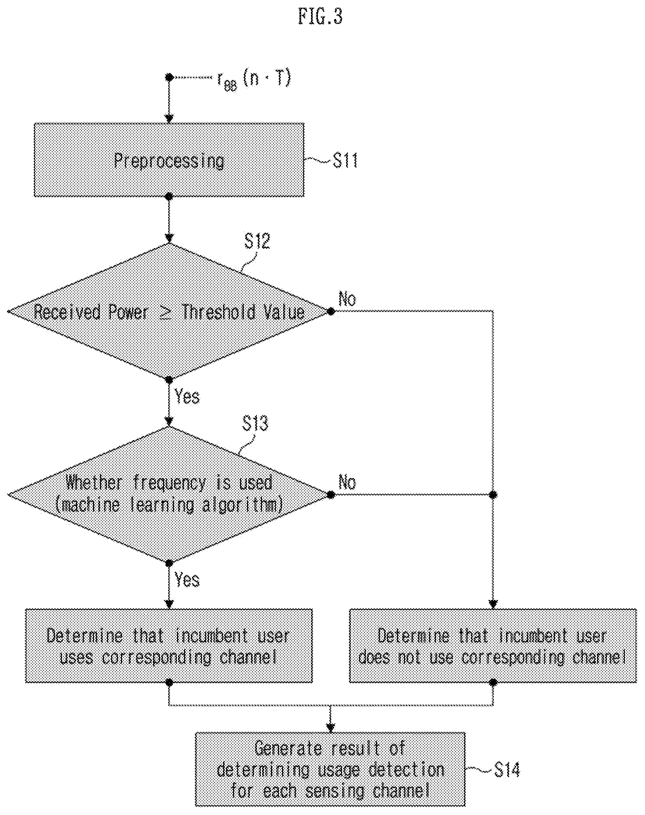

FIG. 3 is a diagram for describing an example of a sensing operation.

The flowchart of FIG. 3 may correspond to an example of the operation of the sensing digital processing unit 104 of FIG. 2.

For example, a received baseband signal r_{BB}(n·T) may be defined as shown in the following equation.

r_{BB}(n·T)=[i_{r_BB}(n·T)+j·q_{r_BB}(n·T)] Equation 1

Here, T corresponds to the sample interval of baseband digital I and Q signals input to the preprocessing step S11. And, n is an integer.

The preprocessing in S11 may include processing such as separating received signals per each sensing channel.

In Steps S12 and S13, for each predetermined sensing channel, when all of the following two conditions are satisfied, it may be determined that an incumbent user uses a corresponding channel.
Condition 1: Received Channel Power≥Threshold Value
Condition 2: The determination result of a machine learning algorithm is ‘YES’.

Regarding Condition 2, since it may not be an incumbent user signal although received channel power is greater than or equal to a threshold value, a machine learning-based algorithm may determine whether it is an incumbent user's signal.

For example, when a machine learning algorithm input for determining whether a frequency is used in S13 is a spectrogram, the preprocessing in S11 may include performing the following processing on baseband I and Q signals. For example, after generating the entire spectrogram for the entire sensing bandwidth (e.g., 100 MHz), it may be simply truncated and separated for each sensing channel (e.g., 10 MHz). In addition, received power for each sensing channel may be calculated.

In this regard, a time duration used to generate one entire spectrogram, whether to allow overlap between time durations used to generate one entire spectrogram and the next entire spectrogram, other time-frequency analysis other than a spectrogram (e.g., Wigner-Ville distribution), etc. may be set. Those settings may be determined as an appropriate value for performance that meets a purpose.

Hereinafter, various examples of the present disclosure that support a built-in self-test described above are described by adding processing for a test signal for checking and monitoring the ‘sensing’ operation of the frequency usage detection sensor described through FIGS. 2 and 3.

For example, a radar probing signal may be utilized as a test signal. Radar may detect a target from the target return signal with low received power through signal processing that uses an inherent characteristic of a probing signal such as a pseudo random binary sequence (PRBS) signal or a linear frequency modulation (LFM) signal, etc.

The present disclosure describes a method for performing checking and monitoring in a wireless back-to-back (B2B) manner in which a test signal such as a probing signal is transmitted through a separate transmitter and a separate transmit antenna and is received by a sensor such as the example of FIG. 2.

In particular, the transmit power of a probing signal may be set to ensure that the received power of a probing signal is at the noise floor level of a receiver, thereby minimizing the impact of self-test and monitoring on sensing performance.

For example, since the power of a test signal received by a sensor is at the noise floor level of a receiver, the impact on sensing performance for detecting an incumbent user signal may be minimal.

In addition, even when a test signal is received at the noise floor level, it is possible to confirm whether a wireless B2B result is at an allowable level in the absence of a sensing target signal through signal processing using an inherent characteristic thereof.

Here, the noise floor of a receiver may include the effect of the noise figure (NF) of a receiver.

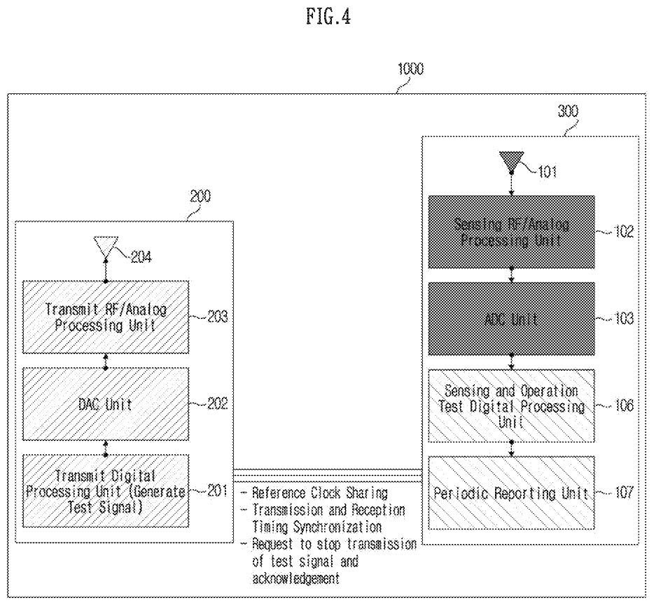

FIG. 4 is a diagram representing an example of the structure of a frequency usage detection sensor with a self-test function according to the present disclosure.

The apparatus 1000 of FIG. 4 may include the test signal transmit subsystem 200 and the sensing and operation test subsystem 300.

In the test signal transmit subsystem 200, the transmit digital processing unit 201 may generate and store a baseband test signal to be transmitted (e.g., a probing signal such as a PRBS or an LFM, etc.).

The digital to analog converter (DAC) unit 202 may convert a digital signal into an analog signal.

The transmit RF/analog processing unit 203 may perform frequency up-conversion (converting an IF or BB signal into an RF signal), amplification, filtering, etc.

The transmit antenna 204 may convert an electric signal to a radio wave.

In the sensing and operation test subsystem 300, since the sensing antenna 101, the sensing RF/analog processing unit 102 and the ADC unit 103 are the same as described in FIG. 2, an overlapping description is omitted.

The sensing and operation test digital processing unit 106 may determine whether a frequency is used in a manner similar to the sensing digital processing unit 104 of FIG. 2, and unlike the sensing digital processing unit 104 of FIG. 2, may test whether a sensing operation is normal (i.e., determine whether a sensing operation is normal or abnormal).

The periodic reporting unit 107 may periodically report a result of determining whether a frequency is used to a spectrum access system in a manner similar to the periodic reporting unit 105 of FIG. 2, and unlike the periodic reporting unit 105 of FIG. 2, may stop reporting when the self-test determines that the sensing operation is abnormal.

Hereinafter, a method for performing sensing by removing a received test signal (e.g., a probing signal for test and monitoring) from a received entire signal is described.

A test signal transmitted from the transmit antenna 204 is referred to as p(t), and a signal received by the sensing antenna 101 in the absence of a sensing target signal may be referred to as r(t)_{(no victim)}. In this case, r(t)_{(no victim)} may be defined as expressed in Equation 2.

r(t)_{(no victim)}=α·p(t−τ) Equation 2

Here, α refers to the attenuation of a signal path and τ refers to the time delay of the signal path. An expression like Equation 2 is based on the premise that one prominent primary signal path is present between a transmit and a receive antenna (hereinafter, primary signal path) in wireless back-to-back (B2B).

A time delay for an RF signal is reflected as the time delay for a baseband (BB) signal and a phase transition corresponding to the delay. Accordingly, a received baseband test signal r_{BB}(t)_{(no victim)} may be expressed as shown in Equation 3.

r_{BB}(t)_{(no victim)}=G_{RX}·α·G_{TX}·p_{BB}(t−τ)·exp(−j2πf_{c}τ) =αₒᵥₑᵣₐₗₗ·p_{BB}(t−τ)·exp(−j2πf_{c}τ) Equation 3

Here, p_{BB}(t) refers to a transmitted baseband test signal, G_{TX} refers to a transmitter gain, G_{RX} refers to a receiver gain, and f_{c} refers to a carrier frequency.

Here, a time delay passing through a transmitter and a receiver may be identified through a prior experiment and compensated.

In FIG. 4, since transmission and reception timing between the subsystems 200 and 300 is synchronized, τ, the time delay of wireless B2B, may be extracted by processing a test signal (e.g., a probing signal). This is self-evident considering a situation in a mono-static radar where a round-trip delay between transmission and reception is extracted and the distance to a target is derived by multiplying half of that time delay by the speed of light in the corresponding medium.

In this case, if it is possible to know αₒᵥₑᵣₐₗₗ(=G_{RX}·α·G_{TX}), it is possible to know a received baseband test signal r_{BB}(t)_{(no victim)}. Here, αₒᵥₑᵣₐₗₗ may be estimated as a value that makes the primary signal path disappear from a result of processing a probing signal in the absence of a target signal. As a result, an estimate of r_{BB}(t)_{(no victim)} may be obtained.

A result of removing the estimate of r_{BB}(t)_{(no victim)} from a received entire baseband signal may be close to a situation where a test signal is not received, and whether an incumbent user uses a frequency may be determined based on this, thereby further reducing the impact of self-test and monitoring through wireless B2B on sensing performance.

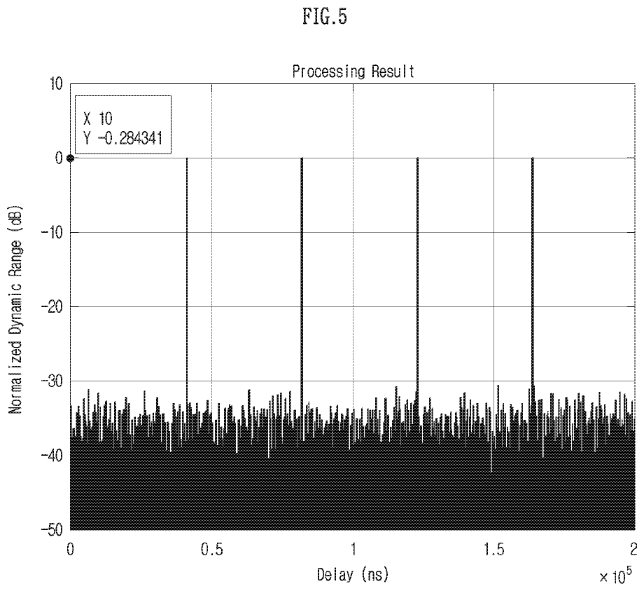

FIG. 5 represents an example of a channel impulse response between a transmit and a receive antenna according to the present disclosure.

The example of FIG. 5 represents an example of the channel impulse response (CIR) between a transmit and a receive antenna when a PRBS signal with a bandwidth of 100 MHz is used as a test signal. The conditions under which that result was obtained are as follows, wherein an SNR is set as 0 dB to represent a situation where a test signal is received at a noise floor level.
PN (pseudo noise) Sequence Length=4095
A root raise cosine (RRC) filter with a roll-off factor of 0.22 is applied to transmission and reception.
f_{c}=3 GHz
τ=10 ns
SNR=0 dB

As described above, it may be seen that a CIR may be confirmed through signal processing using the auto-correlation characteristic of a PN sequence even in a situation where a test signal is received at a noise floor level.

For example, whether a sensing operation is normal currently may be determined by using a state in which a sensing operation is normal as a reference. For example, a firstly measured CIR result through wireless B2B at an installation location after an apparatus (or a sensor) is verified may be considered as a result in a normal operation. Accordingly, the time delay and dynamic range (DR) of the firstly measured CIR in this case may be used as a reference time delay and a reference DR. Referring to the example of FIG. 5, a time delay of 10 ns may become a reference time delay and a DR of 30 dB may become a reference DR.

For example, for a time delay, a value suitable for an installation environment shall be obtained. In other words, a case in which a distance between the transmit antenna 204 and the sensing antenna 101 is about 3 m when a time delay of 10 ns is observed (e.g., 1.5 to 4.5 m when a 100 MHz bandwidth signal is used) may be a value suitable for an installation environment.

For example, when a difference between the time delay and/or DR of the CIR measurement result using a test signal obtained from a test and monitoring process during sensor operation and the time delay and/or DR of a reference CIR is beyond a predetermined range, it is determined that an abnormality is present in a sensing operation, thereby enabling test and monitoring for a normal operation. As described above, since a test signal is received at a noise floor level, the impact on sensing performance that detects a sensing target signal is minimal.

In the examples described above, the state in which the sensor is verified may correspond to, for example, a state in which a sensing performance is verified through wired experiments, a sensing antenna whose characteristics have been confirmed in an antenna chamber, and the sensing performance is verified through wireless experiments in a radio anechoic chamber with the sensing antenna assembled.

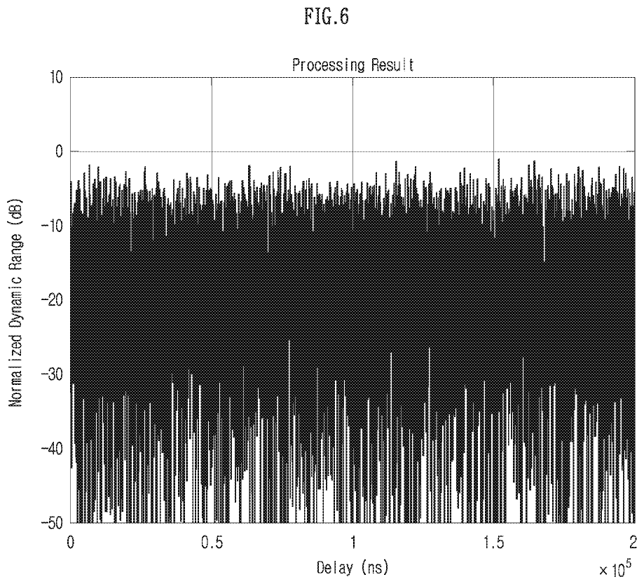

FIG. 6 represents an example of a CIR when the estimate of a baseband test signal is removed from the example of FIG. 5.

A received baseband test signal may correspond to r_{BB}(t)_{(no victim)} in the above-described example. As described above, a result of determining αₒᵥₑᵣₐₗₗ in a direction which makes the primary signal path disappear in the example of FIG. 5 may correspond to the example of FIG. 6. This result shows that a signal path is less visible than a result in an SNR −20 dB situation, although the latter is not separately illustrated.

Accordingly, when sensing for determining whether an incumbent user uses a frequency is performed for a result of removing the estimate of r_{BB}(t)_{(no victim)} from a received baseband signal (i.e., a received entire signal), it becomes a situation where a test signal is received at more than 20 dB lower level than the noise floor of a receiver, so it may be considered that an operation test has almost no impact on sensing performance.

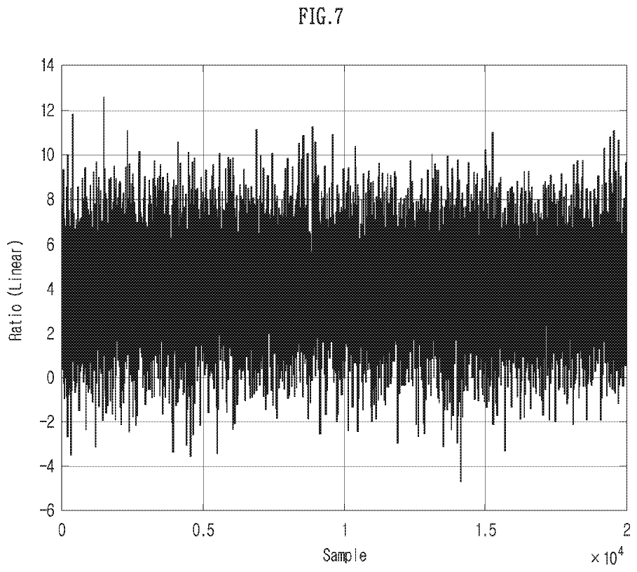

FIG. 7 is a diagram for describing an example of magnitude change estimation for a test signal according to the present disclosure.

For example, the example of FIG. 7 represents the ratio of the real part of r_{BB}(t) _{(no victim)} to the real part of the estimate of r_{BB}(t)_{(no victim)} when αₒᵥₑᵣₐₗₗ is set as 1. The example of FIG. 7 excludes a case in which it is divided by 0 to obtain an infinite value, which represents that ratio fluctuates within a range from −4 to 12. In this case, 4, the median value of a fluctuation range, may be estimated as αₒᵥₑᵣₐₗₗ and applying such an estimation result may correspond to the example of FIG. 6.

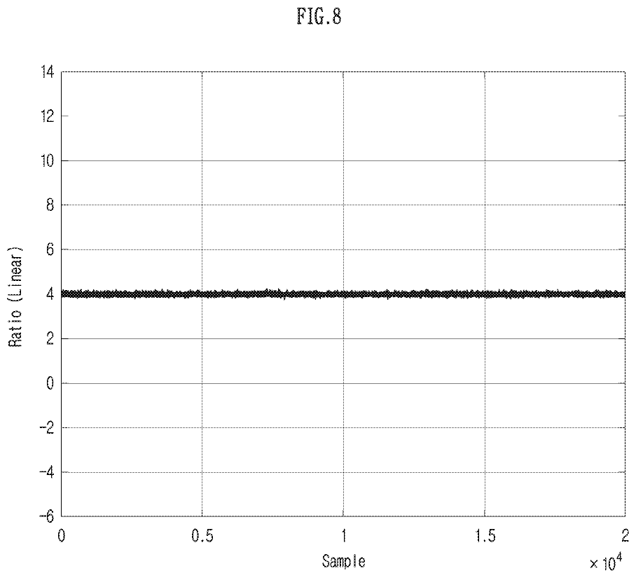

FIG. 8 is a diagram for describing another example of magnitude change estimation for a test signal according to the present disclosure.

For example, the example of FIG. 8 may correspond to the example of FIG. 7 under an SNR 30 dB situation. Since it may be assumed that a large fluctuation range in the example of FIG. 7 results from a low SNR, a case may be considered that αₒᵥₑᵣₐₗₗ is estimated under a situation where an SNR is increased. It corresponds to an example in which the transmit power of a test signal is set to ensure that the received power of the test signal is at a sufficiently higher level than a receiver noise floor at first installation and αₒᵥₑᵣₐₗₗ is estimated under that situation. After estimation, a frequency usage detection sensor may be operated by adjusting the transmit power of the test signal to ensure that the received power of the test signal is at the noise floor level.

Since the signal path of wireless B2B is expected to be a static path, it may be assumed that αₒᵥₑᵣₐₗₗ will not change significantly from the value estimated at first installation. In case where the impact of temperature or humidity, etc. is concerned, a state as shown in the example of FIG. 6 is confirmed at a predetermined interval (e.g., 1 hour) and when the signal path appears larger than before, αₒᵥₑᵣₐₗₗ may be adjusted slightly from the previous estimate to re-estimate it in a direction that makes the signal path disappear.

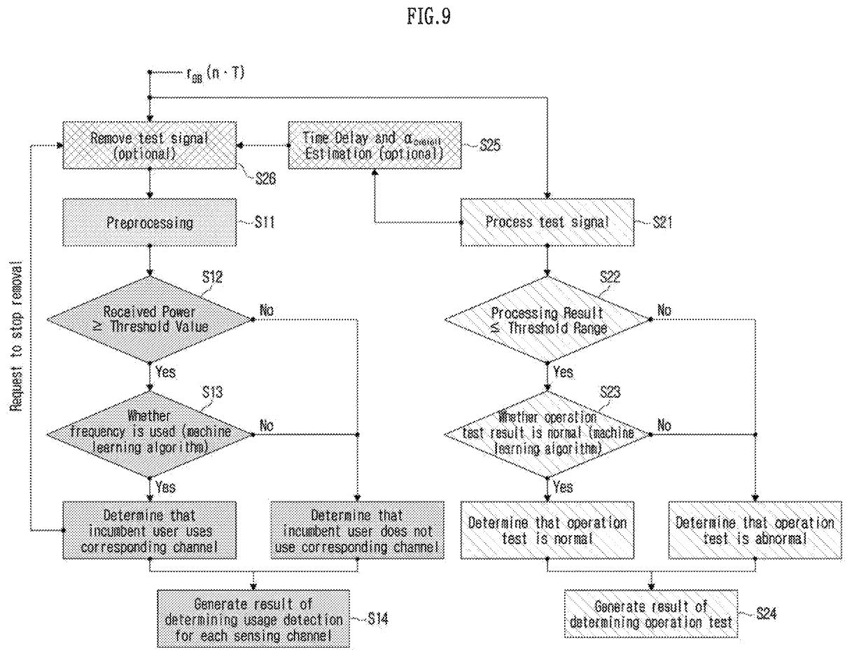

FIG. 9 is a diagram for describing an example of self-test and sensing operations according to the present disclosure.

For example, the operation of FIG. 9 may be performed in the sensing and operation test digital processing unit 106 of FIG. 4.

The test signal processing S21 and the comparison between a processing result and a threshold range S22 may include, for example, determining whether a difference between the time delay and/or DR of the CIR measurement result using a test signal obtained at a test and monitoring process and the time delay and/or DR of a reference CIR is within a predetermined range.

In Step S23, a machine learning algorithm may be used to find a case in which a difference between a CIR measurement result and a reference CIR is within a predetermined range but an abnormality is present in a sensing operation.

In Step S24, when a difference between a CIR measurement result and a reference CIR is beyond a predetermined threshold range or when the output of a machine learning algorithm is ‘abnormal’, it may be determined that an abnormality is present in a sensing operation.

Steps S25 and S26 represent the process of estimating and removing a received baseband test signal (e.g., r_{BB}(t)_{(no victim)}) from a received entire baseband signal (e.g., r_{BB}). A sensing operation may be performed based on a signal from which a test signal is removed. Since S11 to S14 are the same as described in FIG. 3, an overlapping description is omitted.

The determination step of S23 described above is based on the premise that an apparatus including a sensor stores (or keeps) a processing result (e.g., the CIR measurement result using a test signal obtained at a test and monitoring process) for a certain period. Based on a result of operating for a certain period, learning labels may be attached to processing results where a difference from a reference CIR is within a threshold range.

For example, a normal label may be attached when no abnormality is present in a sensor operation. An abnormal label may be attached when an abnormality is present in a sensor operation. For example, when a difference from the reference CIR of a processing result is within a threshold range but it is subsequently confirmed that an abnormality is present in a sensor operation, abnormal labels may be attached to processing results belonging to a corresponding period.

Once training data is collected during operation, a machine learning algorithm that determines whether a difference from the reference CIR of a processing result is within a threshold range but an abnormality is present in a sensing operation may be learned through supervised learning.

For example, the sensing and operation test digital unit 106 may generate a result of determining whether a frequency is used for each sensing channel and a result of determining whether a sensing operation is normal and transmit them to the periodic reporting unit 107.

The periodic reporting unit 107 periodically reports a result of determining whether a frequency is used to a spectrum access system, but may stop reporting when it is determined that a sensing operation is abnormal.

For example, let's consider a case in which results of determining whether a frequency is used and whether a sensing operation is normal are changed from (State 1) to (State 2).
(State 1) Result of determining whether a sensing operation is normal=‘Normal’, Result of determining whether a frequency is used=‘Unused’
(State 2) Result of determining whether a sensing operation is normal=‘Normal or Abnormal’, Result of determining whether a frequency is used=‘Used’

This case may correspond to a case in which the frequency usage of an incumbent user is not detected by a sensor operating normally, but is detected the next moment.

Since operation test performance will deteriorate when an incumbent user signal is present and the most recent determination confirms that no abnormality is present in a sensor, a result of determining an operation test in this case may not be considered.

If a result of determining whether a sensing operation is normal will not be considered when the frequency usage of an incumbent user is detected, there is no reason to transmit a test signal. For example, ‘a request to stop transmitting a test signal and an acknowledgment’ shown in FIG. 4 corresponds to an operation performed in this case. For example, the subsystem 300 may request the subsystem 200 to stop transmitting a test signal and the subsystem 200 may stop transmitting a test signal in response thereto and send an acknowledgment to the subsystem 300.

When a test signal is not transmitted, an operation for removing a received test signal from a received entire signal shall not be performed. For example, an operation for removing the estimate of r_{BB}(t)_{(no victim)} shall not be performed. In FIG. 9, a request to stop removal may correspond to an operation performed in this case.

When a result of determining whether a frequency is used is changed back to ‘Unused’ in (State 2), ‘a request to stop transmission’ and ‘a request to stop removal’ are not sent and then, ‘determine whether a sensing operation is normal’ and ‘determine whether a frequency is used’ may be performed simultaneously again.

The above-described example uses an example in which a probing signal such as a PRBS signal is used as a test signal for test and monitoring, but the examples of the present disclosure may be applied equally even when an LFM signal is used. However, since baseband I and Q signals are generated in a sensing receiver, de-chirping is not performed by mixing a transmitted LFM signal and a received signal in an analog domain, but de-chirping of an LFM signal may be performed in a digital domain.

As an additional example, an RF limiter may be applied to the input side of the sensing RF/analog processing unit 102 of FIG. 4 to prevent hardware damage in a situation where abnormally high power is received by the sensing antenna 101 due to a malicious jamming attempt or an incumbent user's operation error.

In a situation where abnormal high power is received by the sensing antenna 101, a result of determining whether a sensing operation is normal by the sensing and operation test digital processing unit 106 will be ‘abnormal’. In this case, when periodic reporting to a spectrum access system is stopped, a spectrum access system notifies a frequency usage detection sensor operating agency of an abnormality and an abnormality is resolved by an operating agency (e.g., the normal operation of an incumbent user, the blocking/stopping of malicious jamming), it may return back to a normal operation since hardware is not damaged.

In examples described above, the number of samples (or periods) of a test signal, a period per which an operation test is performed and/or a period per which αₒᵥₑᵣₐₗₗ is estimated, etc. used to generate a processing result (e.g., the CIR measurement result using a test signal obtained at a test and monitoring process) may be set and applied as an appropriate value for performance suitable for a purpose.

For example, it may be set how many samples or periods will be used in a test signal to generate a processing result. For example, the example of FIG. 5 represents a processing result using one period of 40.95 us (=10 ns*4095). An SNR may be improved by using N periods. For example, one CIR may be generated by averaging N periods. For example, a CIR may be obtained with one period and Doppler processing for N CIRs may also be applied. For example, a CIR may be obtained by averaging n periods and Doppler processing for m CIRs may also be applied (herein, N=n*m).

For example, an operation test period may be set to be greater than or equal to the time length used to generate a processing result. For example, when a length of 40.95 us is used to generate a processing result, a test/monitoring period may be set to be greater than or equal to 40.95 us. For example, it may be determined how often (e.g., every 10 minutes) test and monitoring are performed. Accordingly, a test signal of N periods may be transmitted and received per that (e.g., every 10 minutes). For example, a test/monitoring operation may be stopped while it is determined that an incumbent user uses a frequency. For example, to perform test/monitoring every 10 minutes, a signal with ‘a period of 10 minutes’ may be generated and the transmission and reception of the test signal of N periods may be performed according to the signal with ‘a period of 10 minutes’. For example, when the transmission and reception of a test signal are stopped because the frequency usage of an incumbent user is detected, test/monitoring may be resumed according to the signal with ‘a period of 10 minutes’ encountered first after a result of determining whether a frequency is used is changed from ‘Yes’ to ‘No’.

For example, the αₒᵥₑᵣₐₗₗ estimation period may be set to determine how often (e.g., every 1 hour) re-estimation will be performed after estimation at first installation.

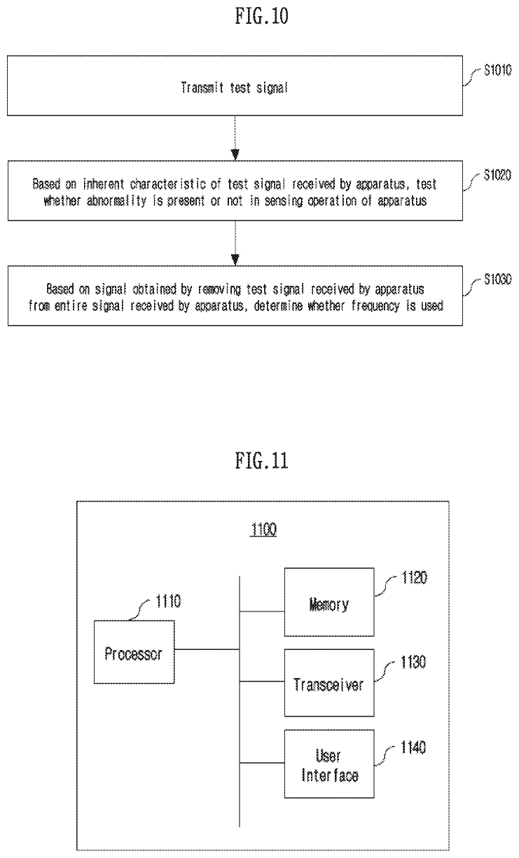

FIG. 10 is a diagram for describing an example of the self-test method and frequency usage detection method of a frequency usage detection sensor according to the present disclosure.

In Step S1010, an apparatus may transmit a test signal.

In some examples, a test signal may be generated based on a pseudo noise (PN) sequence.

In some examples, a test signal may be generated based on an LFM signal.

In some examples, the transmit power of a test signal may be set to ensure that the received power of a test signal is less than or equal to the noise floor of the receiver of an apparatus.

In Step S1020, whether an abnormality is present or not in an apparatus's sensing operation may be tested based on the inherent characteristic of a test signal received by an apparatus.

In some examples, test/monitoring for an apparatus may include determining whether a frequency usage detection sensor operates normally based on a comparison between a CIR measurement result obtained based on the inherent characteristic of a test signal received by an apparatus and a reference CIR. For example, a reference CIR may be set as a CIR between a transmit and a receive antenna measured at first installation after an apparatus is verified. For example, determining whether the sensing operation is normal may be included according to whether a difference in at least one of a time delay or a dynamic range (DR) of a CIR measurement result and a reference CIR is within a predetermined certain range. For example, synchronization and/or a shared clock may be applied to the transmitter and receiver of a test signal within an apparatus.

In some examples, when a difference between a CIR measurement result and a reference CIR is not within a predetermined certain range, it may be determined that the sensing operation of a frequency usage detection sensor is abnormal. If a difference between the CIR measurement result and the reference CIR is within a predetermined certain range, it may be determined that the sensing operation of a frequency usage detection sensor is normal or whether an abnormality is present or not in a sensing operation may be additionally determined based on machine learning.

In some examples, whether a frequency is used may be periodically reported to a spectrum access system. If a test/monitoring result determines that a sensing operation is abnormal, periodic reporting may be stopped.

In Step S1030, whether a frequency is used may be determined based on a signal obtained by removing a test signal received by an apparatus from an entire signal received by an apparatus.

In some examples, removing a test signal received by an apparatus from an entire signal received by the apparatus may include removing the estimate of the baseband signal of the received test signal from the baseband signal of the received entire signal. For example, the estimate of the baseband signal of a received test signal may be obtained by applying a time delay estimation value and a magnitude change estimation value for the baseband signal of a transmitted test signal to the baseband signal of the transmitted test signal. For example, the time delay estimation of the baseband signal of a test signal may be performed by taking a response with the largest dynamic range (DR) in a CIR measurement result between a transmit and a receive antenna, that is, the time delay of a primary signal path, when transmission and reception of a test signal are time-synchronized. For example, magnitude change estimation may be performed based on adjusting a magnitude change value in a direction that reduces the dynamic range (DR) of the primary signal path.

In some examples, determining whether a frequency is used may include determining whether an incumbent user uses a frequency in a specific channel based on a comparison between a predetermined threshold value and a received power in the specific channel of the signal obtained by removing a test signal from an entire signal. For example, when the received power in a specific channel is less than a predetermined threshold value, it may be determined that an incumbent user does not use a frequency in the specific channel, and when the received power in a specific channel is greater than or equal to a predetermined threshold value, it may be determined that an incumbent user uses a frequency in the specific channel or it may include additionally determining whether an incumbent user uses a frequency in the specific channel based on a machine learning algorithm.

In some examples, when a determination on whether a frequency is used determines that an incumbent user uses a frequency, ‘stop transmitting’ a test signal may be requested.

In some examples, the transmission of a test signal is stopped when ‘stop transmission’ is requested, and when the transmission of a test signal is stopped, whether a frequency is used may be determined based on a received entire signal.

This self-monitoring may be performed in an in-situ manner and an in-service manner.

FIG. 11 represents an example of a block diagram of a frequency usage detection sensor with a self-test function according to the present disclosure.

The frequency usage detection sensor apparatus 1100 with a self-test function may include at least one processor 1110, at least one memory 1120, at least one transceiver 1130, at least one user interface 1140, etc. The memory 1120 may be included in the processor 1110 or may be configured separately. The memory 1120 may store an instruction that causes the apparatus 1100 to perform an operation when executed by the processor 1110. The transceiver 1130 may transmit and/or receive a signal, data, etc. exchanged by the apparatus 1100 with other entities. The user interface 1140 may receive a user's input to the apparatus 1100 or may provide the output of the apparatus 1100 to a user. Among the components of the apparatus 1100, components other than the processor 1110 and the memory 1120 may not be included in some cases and other components not illustrated in FIG. 11 may be included in the apparatus 1100.

The processor 1110 may be configured to cause the apparatus 1100 to perform the operation of an apparatus according to various examples of the present disclosure. Although not illustrated in FIG. 11, the processor 1110 may also be configured as a set of modules that perform each function. A module may be configured in the form of hardware and/or software.

In the examples of the present disclosure, a signal transmitted from the transmitter of at least one transceiver 1130 may be received by the receiver of the very at least one transceiver 1130. In particular, a test signal for test/monitoring may operate on the premise that the apparatus 1100 receives a signal transmitted by the apparatus 1100 itself.

For example, the processor 1110 may be configured to transmit a test signal (e.g., a probing signal for test/monitoring) through a specific transmitter among at least one transceiver 1130, perform monitoring on an apparatus based on the inherent characteristic of a test signal received through a specific receiver among at least one transceiver 1130 and determine whether a frequency is used based on a signal obtained by removing a test signal received through a corresponding specific receiver from an entire signal received through a corresponding specific receiver.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented as a computer program signal processed by a computer program product, i.e., a computer program or a computer program execution device tangibly implemented on an information medium (e.g., a machine readable storage device (e.g.: a computer readable medium) or a data processing device) or a data processing device or implemented as a signal propagated to execute the operation of a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. The component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes a detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in the form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. A self-test method of a frequency usage detection sensor, the method comprising:
transmitting a test signal by an apparatus;
based on an inherent characteristic of the test signal received by the apparatus, checking whether a sensing operation of the apparatus is abnormal or not; and
based on a signal obtained by removing the test signal received by the apparatus from an entire signal received by the apparatus, determining whether a frequency is used.

2. The method of claim 1, wherein:
checking whether the sensing operation of the apparatus is abnormal or not includes determining whether a sensing operation is abnormal or not based on a comparison between a reference channel impulse response (CIR) and a CIR measurement result between a transmit and a receive antenna obtained based on the inherent characteristic of the test signal transmitted by the apparatus and received by the apparatus when transmission and reception of the test signal are time-synchronized within the apparatus.

3. The method of claim 2, wherein:
the reference CIR is set as a CIR between a transmit and a receive antenna measured at first installation after the apparatus is verified.

4. The method of claim 2, wherein:
determining whether the sensing operation is abnormal or not based on the comparison between the CIR measurement result and the reference CIR includes determining whether the sensing operation is normal according to whether a difference in at least one of a time delay or a dynamic range (DR) of the CIR measurement result and the reference CIR is within a predetermined certain range.

5. The method of claim 4, wherein the method comprises:
when the difference between the CIR measurement result and the reference CIR is not within the predetermined certain range, determining that the sensing operation of the apparatus has the abnormality or is not normal, and
when the difference between the CIR measurement result and the reference CIR is within the predetermined certain range, determining that the sensing operation of the apparatus does not have the abnormality or is normal or additionally determining whether the sensing operation of the apparatus is abnormal or not based on machine learning.

6. The method of claim 1, wherein:
removing the test signal received by the apparatus from the entire signal received by the apparatus includes removing an estimate of a baseband signal of the received test signal from a baseband signal of the received entire signal.

7. The method of claim 6, wherein:
the estimate of the baseband signal of the received test signal is obtained by applying a time delay estimation value and a magnitude change estimation value for a baseband signal of the transmitted test signal to the baseband signal of the transmitted test signal.

8. The method of claim 7, wherein:
the time delay estimation is performed by taking a response with a largest DR in the CIR measurement result, that is, a time delay of a primary signal path, and
the magnitude change estimation is performed based on adjusting a magnitude change value in a direction that reduces the largest DR of the primary signal path.

9. The method of claim 1, wherein:
the test signal is generated based on a pseudo noise (PN) sequence, and
the inherent characteristic of the test signal is an auto-correlation characteristic of the PN sequence.

10. The method of claim 1, wherein:
in some embodiments of the present disclosure, the test signal is generated based on a linear frequency modulation (LFM) signal, and
the inherent characteristic of the test signal is a de-chirping characteristic of the LFM signal.

11. The method of claim 1, wherein:
determining whether the frequency is used based on the signal obtained by removing the received test signal from the received entire signal includes, based on a comparison between a predetermined threshold value and a received power in a specific channel of the signal obtained by removing the received test signal from the received entire signal, determining whether an incumbent user uses the frequency in the specific channel.

12. The method of claim 11, wherein determining whether the frequency is used based on the signal obtained by removing the received test signal from the received entire signal comprises:
when the received power in the specific channel is less than the predetermined threshold value, determining that the incumbent user does not use the frequency of the specific channel, and
when the received power in the specific channel is greater than or equal to the predetermined threshold value, determining that the incumbent user uses the frequency of the specific channel or additionally determining whether the incumbent user uses the frequency of the specific channel based on a machine learning algorithm.

13. The method of claim 1, wherein:
a sensing result of determining whether the frequency is used is periodically reported to a spectrum access system, and
when it is determined that the sensing operation of the apparatus is abnormal as a result of the self-test, the periodic report is stopped.

14. The method of claim 11, wherein:
when a determination on whether the frequency is used determines that the incumbent user uses the frequency, a transmission of the test signal is stopped in the apparatus.

15. The method of claim 1, wherein:
when a transmission of the test signal is stopped, whether the frequency is used is determined based on the received entire signal.

16. The method of claim 1, wherein:
transmit power of the test signal is set to ensure that received power of the test signal is less than or equal to a noise floor of a receiver of the apparatus.

17. The method of claim 1, wherein:
the self-test is performed in an in-situ manner and an in-service manner.

18. An apparatus for performing a self-test for a frequency usage detection sensor, the apparatus comprising:
at least one transceiver; and
at least one processor,
wherein the at least one processor is configured to:
transmit a test signal through a specific transmitter among the at least one transceiver;
based on an inherent characteristic of the test signal received by a specific receiver among the at least one transceiver, check whether a sensing operation of the apparatus is abnormal or not; and
based on a signal obtained by removing the test signal received by the specific receiver from an entire signal received by the specific receiver, determine whether a frequency is used.

19. At least one non-transitory computer-readable medium for storing at least one instruction, wherein:
the at least one instruction is executed by at least one processor to control an apparatus to perform:
an operation for based on an inherent characteristic of a test signal transmitted by the apparatus and received by the apparatus, checking whether a sensing operation of the apparatus is abnormal or not; and
an operation for based on a signal obtained by removing the test signal received by the apparatus from an entire signal received by the apparatus, determining whether a frequency is used.
